(19) United States
(12) Patent Application Publication
(10) Pub. No.: US 2001/0037011 A1
(43) Pub. Date: Nov. 1, 2001

(54) Process for forming an amide bond

(76) Inventor: Armin Rossler, Tengen (DE)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 09/801,981

(22) Filed: Mar. 8, 2001

Related U.S. Application Data
(60) Provisional application No. 60/190,810, filed on Mar. 21, 2000.

(51) Int. Cl. C08G 69/28

(52) U.S. Cl. 528/332; 528/310; 528/312; 528/322; 528/335; 528/336

(57) ABSTRACT

A process for forming an amide bond comprising reacting a carboxylic acid with an amine carboxylate salt, in the presence of an inorganic base.

### FIELD OF THE INVENTION

### BACKGROUND OF THE INVENTION

The present invention relates to a process for forming an amide bond, comprising reacting a carboxylic acid with an amine carboxylate salt, in the presence of an inorganic base. More particularly, the process employs the inorganic base as a reagent to precipitate the salt product of the inorganic base cation and the carboxylate anion.

Typically, the formation of an amide bond is carried out by reacting a carboxylic acid with a free amine or a salt of the amine, in the presence of a coupling agent and in the presence of a base. When the amine is reacted in the form of a carboxylate salt, this method generally includes a separate step in which the amine salt is converted to a free amine prior to coupling, as the carboxylate anion may interfere with the coupling, resulting in undesired side products. (Bodansky, M., Principles of Peptide Coupling, 2^{nd} Edition, Springer-Verlag, 1993).

Thus there exists a need for a process which does not require conversion of the amine carboxylate salt to the free amine in a separate step prior to coupling and is therefore more compatible with large scale production needs.

The current invention relates to a more efficient method for forming amide bonds, useful in the synthesis of compounds containing amide bonds, particularly synthesis of peptides and peptide-like compounds.

### BRIEF DESCRIPTION OF THE INVENTION

The invention relates to a process for forming an amide bond comprising reacting a carboxylic acid with an amine carboxylate salt, in the presence of an inorganic base, wherein the salt product of the inorganic base cation and the carboxylate anion has a solubility in water or a polar organic solvent less than or equal to about 5 part/100 parts water or polar organic solvent, at a pH in the range of from about 5-10, to yield the corresponding amide and a precipitate of the salt product of the inorganic base cation and the carboxylate anion.

The process of this invention, as described herein, is advantageous over previously disclosed methods in that it does not require conversion of the amine salt to the free amine in a separate step prior to coupling.

### DETAILED DESCRIPTION OF THE INVENTION

As used herein, the term “amine carboxylate salt”, shall denote a carboxylic acid salt of a primary or secondary amine, such that the salt product of the carboxylate anion with the inorganic base cation has a solubility in water or polar organic solvent of less than or equal to about 5 part/100 parts water or polar organic solvent, preferably less than or equal to about 1 part/100 parts water or polar organic solvent. Suitable examples of the carboxylic acid (an organic acid characterized by the presence of one or more -COOH groups) include tartaric, succinic, oxalic, malonic, fumaric, maleic, phthalic, citric, and the like. Preferably, the carboxylic acid is a 1,2- or 1,3-di-carboxylic acid, such as tartaric, and the like.

As used herein, the term “inorganic base” shall mean any inorganic base whose cation, when combined with the carboxylate anion of the amine carboxylate salt, results in a salt product having a solubility in water or polar organic solvent of less than or equal to about 5 part/100 parts water or polar organic solvent, preferably less than or equal to about 1 part/100 parts water or polar organic solvent. Suitable examples of the inorganic base include calcium hydroxide, barium hydroxide, strontium hydroxide, and the like.

The present invention relates to a process for forming an amide bond comprising reacting a carboxylic acid with an amine carboxylate salt, in the presence of an inorganic base, wherein the salt product of the inorganic base cation and the carboxylate anion has a solubility in water or a polar organic solvent less than or equal to about 5 part/100 parts water or polar organic solvent, at a pH in the range of from about 5-10, as outlined in Scheme 1.

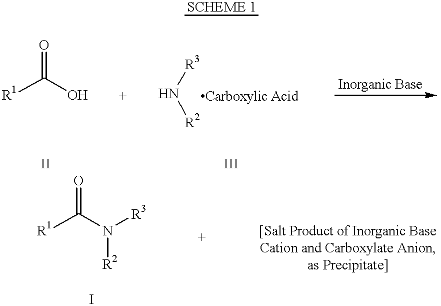

More specifically, a carboxylic acid of formula II, wherein R¹ is any organic side chain, such as an amino acid side chain,

is reacted with an amine carboxylate salt of formula III, such as tartaric, succinic, oxalic, malonic, fumaric, maleic, phthalic, citric, and the like, preferably tartaric; wherein R² and R³ are independently any organic side chain, such as an amino acid side chain or are taken together to form a cyclic secondary amine;

in the presence of a coupling reagent such as 1,3-dicyclohexylcarbodiimide (DCC), 0-benzotriazole-1-yl-N,N,N′,N′-tetramethyluronium hexafluorophosphate (HBTU), or 1-(3-dimethylaminopropyl)-3-ethylcarbodiimide hydrochloride, preferably DCC;

in the presence of 0 to 1 equivalents, preferably 0.1 equivalents of an additive such as 1- hydroxybenzotriazole hydrate (HOBT) or 3,4-dihydro-3-hydroxy-4-oxo-1,2,3-benzotriazine (HOOBT), preferably HOBT; preferably DCC and HOBT;

with addition of an inorganic base, wherein the inorganic base is selected such that the salt product of the inorganic base cation and the carboxylate anion has a solubility in water or a polar organic solvent less than or equal to about 5 part/100 parts water or polar organic solvent, preferably less than or equal to about 1 part/100 parts water or polar organic solvent; such as calcium hydroxide, barium hydroxide, strontium hydroxide, and the like, preferably calcium hydroxide; wherein the inorganic base is present in an amount equal to at least 1 equivalent;

in a solvent mixture of an organic solvent and water, such as, ethyl acetate/water or tetrahydrofuran/water or a polar organic solvent, such as dimethylformamide or 1-methyl-2-pyrrolidinone (NMP);

at a pH in the range of from about 5-10, preferably about 6-7;

preferably at a temperature in the range of about 0-50° C.,

to form the corresponding amide of formula I and a precipitate of the salt product of the inorganic base cation and the carboxylate anion.

In a preferred embodiment of the present invention, the amine carboxylate salt is a tartaric acid salt and the inorganic base is calcium hydroxide.

One skilled in the art will appreciate that although the instant process is suitable for forming any amide bond, carboxylic acids of formula II and amine carboxylate salts of formula III containing additional reactive functional groups will need to be protected. Moreover, the skilled artisan will recognize that a vast number of protective groups are available and suitable for use in such instances. See Greene, T. W., Wuts, P. G. M., Protective Groups in Organic Synthesis (2^{nd} Edition, 1991).

The following examples describe the invention in greater detail and are intended to illustrate the invention, but not to limit it.

### EXAMPLE 1

Methyl [S-(R*,S*)-β-[[[1-[1-oxo-3-(1-benzyloxycarbonyl-4-piperidinyl)propyl]-3-piperidinyl]carbonyl]amino]-3-pyridine propanoate

(R)-1-[3-(1-benzyloxycarbonyl-4-piperidyl)-propionyl]-3-piperidinecarboxylic acid (1 kg, 2.48 mol), methyl (S)-3-amino-3-(3-pyridyl)propanoate tartrate (where the tartrate is present as a hemi-tartrate) (0.7 kg, 2.73 mol) and HOBT (38 g, 0.25 mol) were added to a reaction vessel. To the mixture was added a previously prepared cold solution (0-5° C.) of KH₂PO₄ (96.8 g, 0.71 mol) and Na₂HPO₄ (69.2 g, 0.49 mol) in water (3 kg) and THF (2 kg). The pH was then adjusted to 6.0-6.4 using calcium hydroxide (110 g). The resulting suspension was cooled to 0-5° C. and a solution of DCC (564 g, 2.73 mol) in THF (1 kg) was added. The mixture was stirred for 1 h at 0-5° C., warmed to 20-25° C. and stirred for 4 h. The suspension was cooled to 0-5° C. and ethyl acetate (2 kg) was added. After 15 minutes, the precipitate (a mixture of DCU and calcium tartrate) was filtered off and washed with pre-cooled THF (1 kg). The phases were separated and the organic phase was washed with 5% NaHCO₃ (1 kg). The organic phase was concentrated at 40-50° C., the residual oil was dissolved in THF (1 kg) and evaporated to dryness to afford methyl [S-(R*,S*)-β[-[[1-1-oxo-3-(1-benzyloxycarbonyl-4-piperidinyl)propyl]-3-piperidinyl]carbonyl]amino]-3-pyridine propanoate as an oil.

### EXAMPLE 2

### Methyl N-(1-oxo-3-phenylpropyl)-3-aminobutanoate

A mixture of 3-phenylpropanoic acid (1 mole) and methyl 3-aminobate tartrate salt (1 mole) in THF (500 mL) and water (500 mL) is stirred at room temperature and then treated with Ba(OH)₂ (1-1.1 mole) [a slight excess of Ba(OH)₂ may be needed to maintain the pH between 7-10; a white precipitate of Ba-tartrate is formed immediately following the addition of Ba(OH)₂]. The reaction mixture is cooled to 0-10° C. and treated with HOBT (0.1-0.5 mole) and DCC (1 mole) in THF (500 mL). The reaction mixture is stirred at room temperature until analysis indicates that the reaction is complete. The reaction mixture is cooled to 0-5° C. and treated with ethyl acetate (500-800 mL). The resulting mixture is filtered to remove the precipitate and results in a biphasic filtrate. The top organic layer is separated and washed with 5% aqueous Na₂CO₃ solution and then dried with MgSO₄. The solvent is evaporated to yield the crude product, which is purified as desired.

We claim:

1. A process for forming an amide bond, comprising reacting a carboxylic acid with an amine carboxylate salt, in the presence of an inorganic base, wherein the salt product of the inorganic base cation and the carboxylate anion has a solubility in water or a polar organic solvent less than or equal to about 5 part/100 parts water or polar organic solvent, at a pH in the range of about 5-10.

2. The process of claim 1 wherein the amine carboxylate salt is selected from the group consisting of tartaric, succinic, fumaric, oxalic, malonic maleic, phthalic and citric.

3. The process of claim 2 wherein the amine carboxylate salt is a tartaric acid salt.

4. The process of claim 1 wherein the inorganic base is selected from the group consisting of calcium hydroxide, barium hydroxide and strontium hydroxide.

5. The process of claim 4 wherein the inorganic base is calcium hydroxide.

6. The process of claim 1 wherein the amine carboxylate salt is a tartaric acid salt and the inorganic base is calcium hydroxide.

7. The process of claim 1 wherein the salt product of the inorganic base cation and the carboxylate anion has a solubility in water or a polar organic solvent less than or equal to about 1 part/100 parts water or polar organic solvent

8. The process of claim 1 wherein the pH is in the range of about 6-7.
